(19) United States
(12) Patent Application Publication
(10) Pub. No.: US 2008/0256873 A1
(43) Pub. Date: Oct. 23, 2008

(54) Automatic sliding door closing device

(76) Inventor: Virgil de la Cruz, Stamford, CT (US)

Correspondence Address: Paul D. Greeley;Ohlandt, Greeley, Ruggiero & Perle, L.L.P., One Landmark Square, 10th Floor, Stamford, CT, 06901-2682, US

(21) Appl. No.: 12/148,220

(22) Filed: Apr. 17, 2008

Related U.S. Application Data
(60) Provisional application No. 60/925,248, filed on Apr. 19, 2007.

(51) Int. Cl. E05F 15/06

(52) U.S. Cl. 49/360; 49/506

(57) ABSTRACT

An automatic closing device for returning a sliding section of a sliding door assembly to a closed position without application of an external force. The automatic closing device has a controlled return mechanism that has an adjustable mass assembly and a spring. The controlled return mechanism generates a force that returns the sliding section to its closed position after the sliding section is opened. The controlled return mechanism has a connector having a first end and a second end. The first end of the connector is attached to a fixed position on the sliding door assembly and the second end of the connector is attached to a top end of the controlled return mechanism. The controlled return mechanism has a pulley assembly having a plurality of pulleys that guides the connector from the top end of the controlled return mechanism to the fixed position on the sliding door assembly.

### CROSS REFERENCE TO RELATED PATENT APPLICATIONS

The present application is a Utility Application that claims priority of U.S. Provisional Application No. 60/925,248 filed on Apr. 19, 2007. The provisional application is hereby incorporated herein by reference in its entirety.

### BACKGROUND OF THE INVENTION

1. Field of the Invention

The present disclosure relates to an automatic closing device for a sliding door, sliding screen door, sliding window or similar assemblies, such as a sliding access panel.

2. Description of Related Art

Sliding doors and windows are commonly used in both residential and commercial buildings to provide access to the outside or to connect two rooms or spaces. Such sliding assemblies have two distinct sections including a fixed section and a sliding section that are aligned parallel and adjacent to one another. Additionally, sliding assemblies can include a third sliding section referred to as the screen door. The sliding section normally rolls on a lower horizontal frame of the door on wheels that move along a track. Additionally, such sliding door assemblies may have hangers with wheels to roll along a track attached to an upper horizontal frame of the door assembly.

A person walking through a sliding door may be rushing, may be carrying something that makes it awkward to stop and turn around, or simply forget to close the door. Consequently, sliding doors are often inadvertently left in their open position. This can result in unwanted debris in the interior of the building, a considerable waste of energy if heated or cooled air is allowed to escape, and safety hazards if unwanted persons, insects, or animals are able to freely enter or leave the premises, or young children are presented with the temptation of escaping into dangerous outside conditions.

Traditional automatic sliding door or sliding window closing devices cannot be readily adjusted to the requirements of differing components of the sliding door assemblies. Consequently, traditional closing devices tend to accumulate excess force as the door or window is opened in order to have sufficient remaining force as the door travels to the closed position to fully close the door. This makes the door harder to open and causes it to slam towards the closed position. Traditional closing devices have no provisions for holding the door or window open at any point in its travel. Furthermore, traditional closing devices are cumbersome, heavy, difficult to maintain and expensive.

Accordingly, there is need for an automatic closing device for a sliding door, sliding window, or similar assemblies, such as a sliding access panel, that is compact, easy to maintain, cost affordable and capable of supplying a controlled and adjustable force as the door retracts to its closed position. There is a further need for an automatic closing device that optionally can hold a sliding door, sliding window, or similar assemblies open at any position along its travel.

### BRIEF SUMMARY OF THE INVENTION

The present disclosure provides an automatic closing device for a sliding door or a sliding window that is adjustable to modify its closing speed.

The present disclosure also provides an automatic closing device for a sliding door or a sliding window that is detachable from the door or window to deactivate the device.

The present disclosure further provides an automatic closing device a sliding door or a sliding window that has a latching mechanism that holds open, or releases, the sliding section of the door or window at any point in its travel.

The present disclosure even further provides an automatic closing device for a sliding door or a sliding window having a controlled return mechanism that provides the minimum force necessary to return the sliding door or window to its closed position.

These and other advantages and benefits of the present disclosure are provided by an automatic closing device mounted or integrated on a sliding door assembly. In an exemplary embodiment, a sliding door assembly has an optional fixed immovable section and a sliding section, such as the screen door, that is slidably engaged with a lower horizontal rolling track and an upper horizontal rolling track. The sliding section moves horizontally between a first closed position and a second open position. A fixed vertical frame extends from the lower horizontal track to the upper horizontal track. In an exemplary embodiment, the fixed vertical frame is the edge of the immovable section at the center of the sliding door assembly. The automatic closing device is mounted on or within the fixed vertical frame. The automatic closing device has a connector that is attached to the sliding section of the sliding door assembly that activates a controlled return mechanism when the sliding section is moved toward its open position. The controlled return mechanism provides the force necessary to return the sliding section to the closed position without application of an external force.

As used herein, the terms “sliding section”, “sliding door” and “sliding door assembly” are defined to include a sliding door, a sliding screen door, a sliding window, a sliding access panel, a pocket door, or any similar sliding unit.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 is a perspective view of a sliding door assembly in a partially open position having the automatic closing device of the present disclosure installed thereon.

FIG. 2 is a perspective view of the sliding door assembly of FIG. 1 in a fully retracted position.

FIG. 3 is a perspective view of an automatic closing device of the present disclosure.

FIG. 3a is a perspective view of a block and tackle arrangement of an automatic closing device of the present disclosure.

FIG. 4 is a perspective view of a two-pulley assembly of the present disclosure.

FIG. 5 is a perspective view of a three-pulley assembly of the present disclosure.

FIG. 6 is a perspective view of a four-pulley assembly of the present disclosure.

FIG. 7 is a perspective view of a door latching mechanism of the present disclosure.

### DETAILED DESCRIPTION OF THE INVENTION

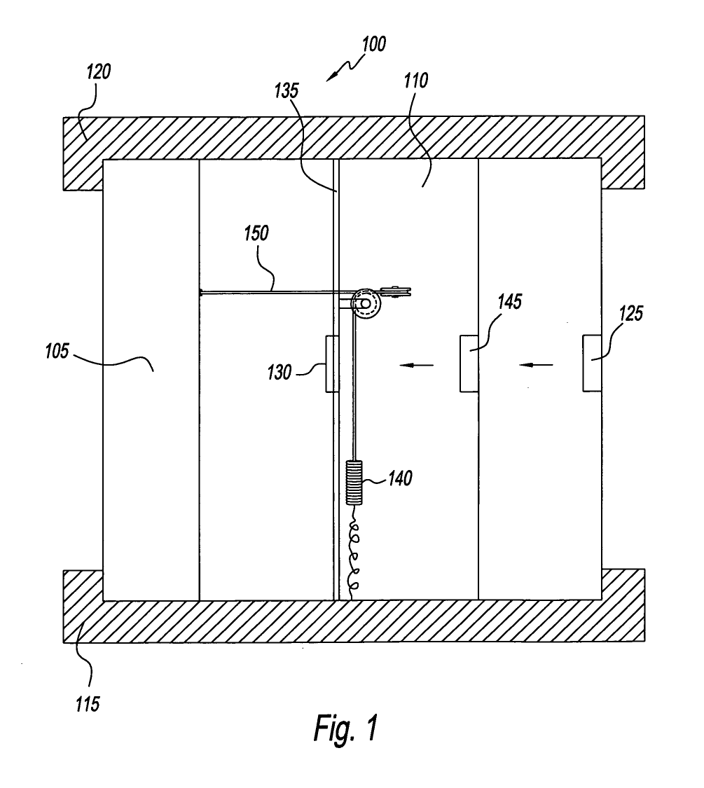

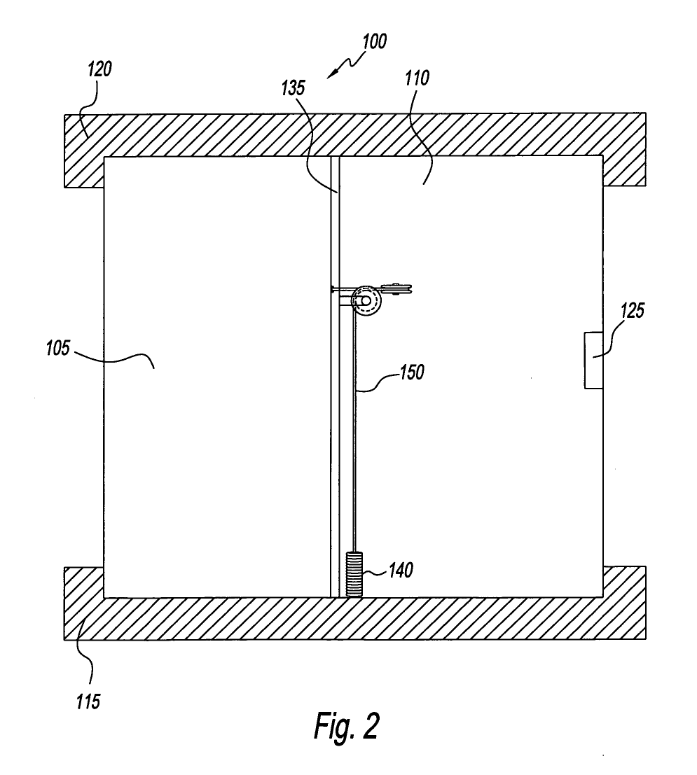

Referring now to the drawings and in particular FIG. 1 and FIG. 2, a sliding door assembly generally referred to by reference number 100 is shown. Of course, it is contemplated by the present disclosure for sliding door assembly 100 to be a screen door, pocket door, hanging door, closet bypass door, sliding window, cabinet door, access panel, or similar assemblies in an alternative embodiment of the present disclosure. Sliding door assembly 100 includes a fixed, immovable section 105 and a sliding section 110, such as a screen door. Sliding section 110 is engaged with a lower horizontal rolling track 115 and an upper horizontal rolling or sliding track 120. Sliding section 110 moves laterally between a first closed position 125 and a second open position 130. A fixed vertical frame 135 extends from lower track 115 to upper track 120. In an exemplary embodiment, vertical frame 135 is part of fixed, immovable section 105.

In the illustrated embodiment, the following description applies to a sliding door assembly having a right sliding section and a left fixed section, as viewed from the inside; positions are reversed for a left sliding door. Sliding door assembly 100 includes an automatic closing device 140. Automatic closing device 140 is installed vertically on the right side of fixed vertical frame 135. In an exemplary embodiment, automatic closing device 140 is factory installed within fixed vertical frame 135 as an integral part of sliding door assembly 100. In an exemplary embodiment of a hanging door, automatic closing device 140 is mounted on a vertical bracket (not shown) attached to an upper portion of the frame of sliding door assembly 100.

In FIG. 1, sliding section 110 is in a partially open position 145. In FIG. 2, sliding section 110 is in fully closed position 125. In FIG. 2, automatic closing device 140 is fully retracted to its non-expanded position.

FIG. 1 and FIG. 2 further illustrate a connector 150 attached to sliding section 110 within the upper third quarter of the height of the sliding section 110, measured from lower horizontal rolling track 115. Such a point of attachment prevents the tendency for sliding section 110 to cock and stick in the rolling tracks when opening or closing. Connector 150 is attached to the vertical edge of sliding section 110 that is farthest from the opening when the door is open. In an exemplary embodiment, connector 150 is attached as high as possible within the upper third quarter of the height of sliding section 110 to allow for the widest possible range of travel of sliding section 110. Wider doors can accommodate even higher points of attachment for connector 150.

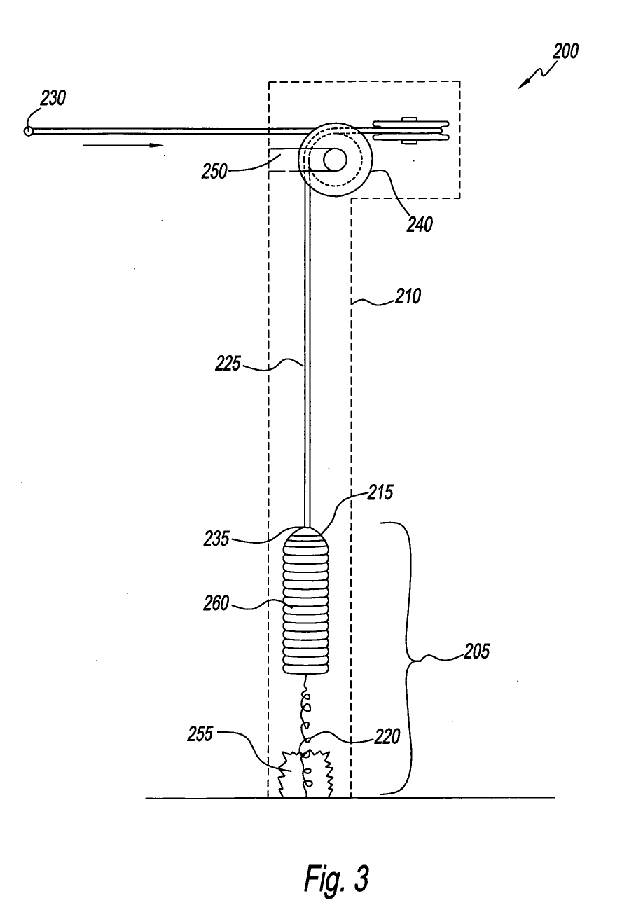

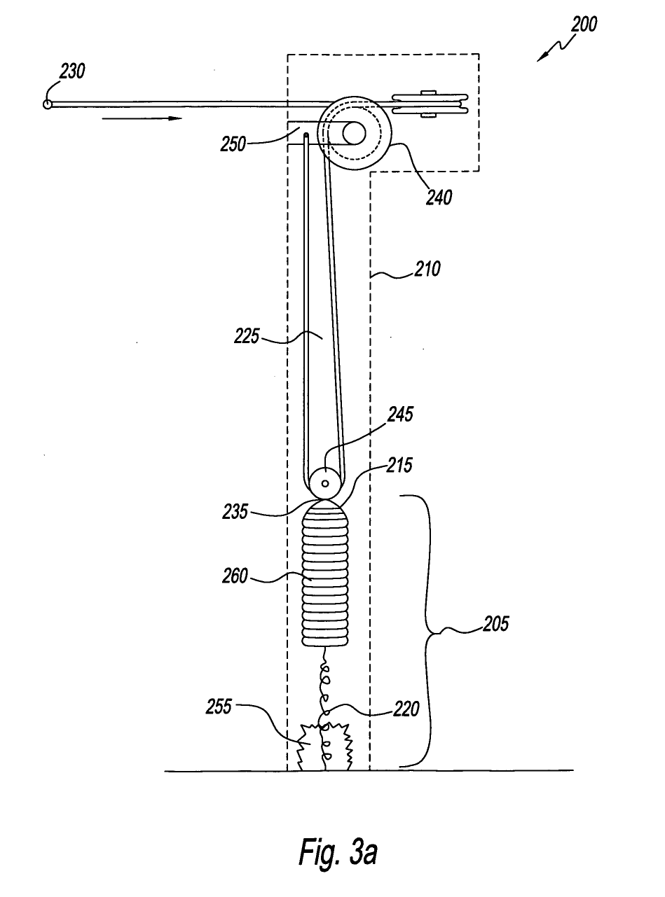

Referring now to FIG. 3, an automatic closing device generally referred to by reference number 200 is shown. Automatic closing device 200 has a controlled return mechanism 205 that generates a force that returns the sliding door to its closed position after the door is opened. The force may be any combination of a spring force, weighted force, magnetic force, hydraulic force, and pneumatic force. In an exemplary embodiment, automatic closing device 200 has a cover 210 that provides a streamlined appearance and protection to the individual components within automatic closing device 200.

In an exemplary embodiment, controlled return mechanism 205 has an adjustable mass assembly 215 and a spring 220. Spring 220 is attached to adjustable mass assembly 215 at one end and to the bottom portion of cover 210 at the other end. Adjustable mass assembly 215 can be increased of decreased by adding or removing weight sections 260 to overcome the rolling friction of the sliding door. An inertial weight (not shown) can also be attached to the sliding door to provide additional momentum to overcome rolling friction. In an exemplary embodiment, weight sections 260 are a plurality of metal washers that are notched to permit adding to or removing from adjustable mass assembly 215. However, it is contemplated by the present disclosure for weight sections 260 to be any other suitable material for adjusting mass such as water, lead shot, sand, or similarly dense material.

Spring 220 provides a force that is required to overcome the static friction to initially get the door moving. When the sliding door is released, adjustable mass assembly 215 and spring 220 provide the force necessary to overcome static and rolling frictional forces of the sliding door and return the sliding door to its closed position. As the sliding door approaches the closed position, the spring force needed to overcome the initial static friction decays and adjustable mass assembly 215 continues to close the door without slamming.

In an exemplary embodiment, controlled return mechanism 205 can be a linear actuator, air piston assembly, hydraulic closing assembly, or a series of magnets. In yet another exemplary embodiment, spring 220 can be an elastic cord or strap.

Automatic closing device 200 has a connector 225. Connector 225 is attached to a fixed position 230 on the sliding door at one end and to the top end 235 of controlled return mechanism 205 at the other end. In an exemplary embodiment, fixed position 230 is a bracket. Connector 225 accumulates tension when the sliding door is moved to an open position. Upon release of the door, connector 225 returns the sliding door to a closed position without application of an external force. In an exemplary embodiment, connector 225 is a cord. Of course, it is contemplated by the present disclosure for connector 225 to be a wire, rope, string, chain, webbing, line, cable or similar component.

Connector 225 is guided from top end 235 of controlled return mechanism 205 to fixed position 230 on the sliding door by a pulley assembly 240 having a plurality of pulleys disposed in a horizontal and/or a vertical plane. In an exemplary embodiment, a friction brake (not shown) acts on the plurality of pulleys to control the door closing speed. Additionally, protective covers may be placed around the grooves of the plurality of pulleys to prevent connector 225 from being dislodged off the grooves of the pulleys.

Referring now to FIG. 3a, an automatic closing device generally referred to by reference number 200 is shown that is applicable to sliding doors that are wider than about three feet. Automatic closing device 200 has an extender pulley 245 attached to top end 235 of controlled return mechanism 205. Connector 225 wraps around extender pulley 245 and is redirected upwards where it is attached to a bracket 250 that holds pulley assembly 240 at the point where connector 225 enters automatic closing device 200. Extender pulley 245 provides a block and tackle arrangement that essentially doubles the possible door travel distance accommodated by automatic closing device 200.

In an exemplary embodiment, automatic closing device 200 has at least one bumper 255 positioned under adjustable mass assembly 215 that cushions the descent of adjustable mass assembly 215. Of course, it is contemplated by the present disclosure for bumper 255 to be a spring, foam, pad, rubber pad, bubble wrap, inflated cushion or any similar cushioning material.

In operation, a person walking through the door manually slides the door to the open position. In doing so, connector 225, acting through pulley assembly 240, raises adjustable mass assembly 215 and stretches spring 220 inside adjustable mass assembly 215. When the person has passed through and releases the door, the combined force of adjustable mass assembly 215 and spring 220, acting through connector 225, returns the door to its closed position. The tension previously accumulated in spring 220 decays and vanishes as the door approaches the closed position, while adjustable mass assembly 215 continues to pull the door to the closed position without slamming.

Advantageously, automatic closing device 200 is capable of adjusting the closing speed of the door and can detach from fixed position 230 to deactivate the device. Automatic closing device 200 provides an optional automatic, single-motion feature for holding the door open or releasing it to close. Additionally, automatic closing device 200 is adaptable to doors and similar components of different widths and heights.

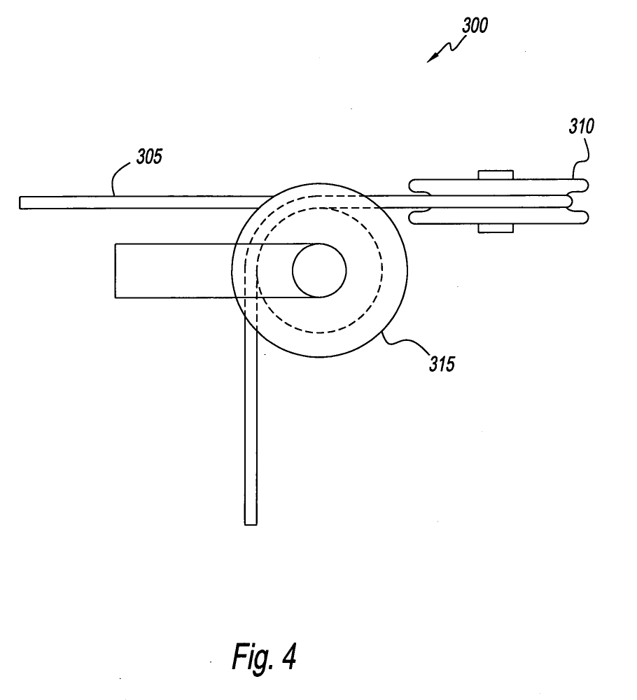

Referring now to FIG. 4, the pulley assembly disposed in the automatic closing device of FIG. 3 generally referred to by reference number 300 is shown. Pulley assembly 300 provides a connector 305 that loops around a first pulley 310 disposed in a horizontal plane. Connector 305 loops again around a second pulley 315 disposed in a vertical plane, thus changing direction from horizontal to downward vertical.

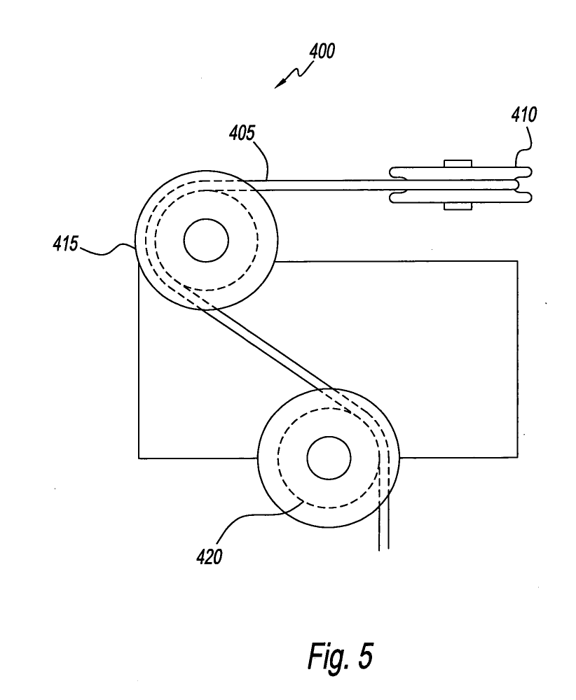

Referring now to FIG. 5, a pulley assembly generally referred to by reference number 400 is shown. Pulley assembly 400 provides a connector 405 that loops around a first pulley 410 disposed in a horizontal plane. Connector 405 loops again around a second pulley 415 disposed in a vertical plane. Connector 405 then loops again around a third pulley 420 disposed in a vertical plane.

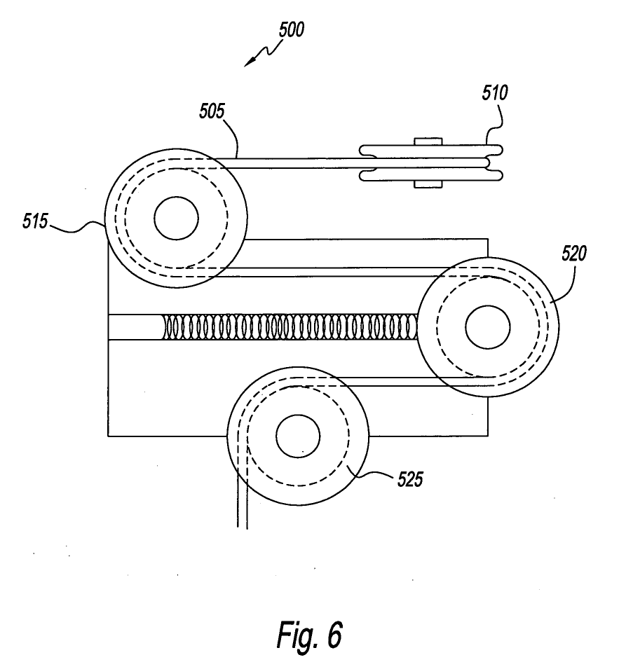

Referring now to FIG. 6, a pulley assembly generally referred to by reference number 500 is shown. Pulley assembly 500 provides a connector 505 that loops around a first pulley 510 disposed in a horizontal plane. Connector 505 loops again around a second pulley 515 disposed in a vertical plane. Connector 505 then loops again around a third spring-loaded pulley 520 disposed in a vertical plane. Connector 505 next loops around a fourth pulley 525 disposed in a vertical plane that changes the direction from horizontal to downward vertical.

Spring-loaded pulley 520 acts as a tensioner that takes up any slack that could accumulate in connector 505 if the sliding door is suddenly jerked open. Thus, spring-loaded pulley 520 eliminates slack in connector 505 and provides additional tension on connector 505 before the adjustable mass is lifted. Spring-loaded pulley 520 further provides an additional pull as the door is closing that drives the door back to its closed position as the weight settles and the tension in connector 505 decreases.

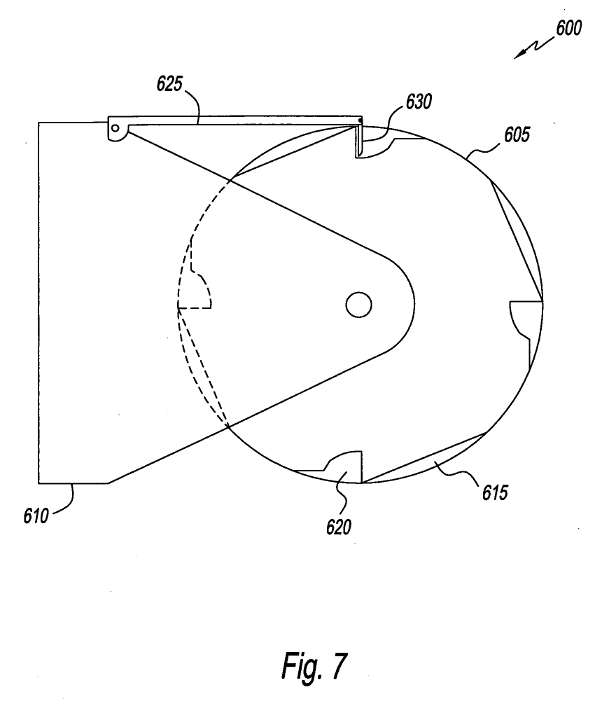

In another exemplary embodiment illustrated in FIG. 7, a single-motion door latching mechanism generally referred to by reference number 600 is shown. Door latching mechanism 600 is incorporated on a pulley 605 of the automatic sliding door closing device. This pulley becomes a latching pulley. Latching pulley 605 is one of the pulleys disposed in a vertical plane. Door latching mechanism 600 is configured to hold open, or release to close, the sliding section of a sliding door assembly at any position along its travel. A plurality of ramps 615 and a plurality of notches 620 are disposed around the circumference of latching pulley 605. In an exemplary embodiment, ramps 615 and notches 620 are evenly disposed around the circumference of latching pulley 605. Each notch 620 provides a fine and discrete position along the travel of the door where the door can be held open. A finger-like lever 625 is pivot mounted on bracket 610. The end of lever 625 is fitted with a hinged claw 630 that swings within a limited arc. The leading edge of hinged claw 630 is curved to facilitate a sliding action along the plurality of ramps 615 of pulley 605.

As the door is opened, latching pulley 605 rotates clockwise. Lever 625 and hinged claw 630 slide over plurality of ramps 615 and plurality of notches 620 without impairing the movement of the sliding door. As the door closes, latching pulley 605 rotates counterclockwise. When the door is released at its regular speed, lever 625 and hinged claw 630 roll over plurality of ramps 615 and plurality of notches 620. However, if the door is opened and then released slowly, hinged claw 630 has sufficient time to drop down and latch into one of the notches, thereby holding the door open at that particular point in its travel. This latching action can be activated at any point of the door travel by releasing the door slowly. To disengage hinged claw 630 from notch 620, the door is gently pushed in the open direction and released at its regular speed.

While the present disclosure has been described with reference to one or more exemplary embodiments, it will be understood by those skilled in the art that various changes may be made and equivalents may be substituted for elements thereof without departing from the scope of the present disclosure. For example, the disclosure references only sliding door assemblies, although the disclosure is also applicable to sliding windows and similar assemblies. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. An automatic closing device for returning a sliding section of a sliding door assembly to a closed position without application of an external force comprising:
a controlled return mechanism having an adjustable mass assembly and a spring, wherein said controlled return mechanism generates a force that returns said sliding section to its closed position after said sliding section is opened;
a connector having a first end and a second end, wherein said first end of said connector is attached to a fixed position on said sliding door assembly, wherein said second end of said connector is attached to a top end of said controlled return mechanism; and
a pulley assembly having a plurality of pulleys that guide said connector from said top end of said controlled return mechanism to said fixed position on said sliding door assembly.

2. The automatic closing device of claim 1, further comprising a cover that provides a streamlined appearance and protection to said automatic closing device.

3. The automatic closing device of claim 1, wherein said adjustable mass assembly has removable weight sections that can be added or removed to overcome rolling friction of said sliding section.

4. The automatic closing device of claim 3, wherein said removable weight sections are selected from the group consisting of a plurality of notched metal washers, water, lead shot, and sand.

5. The automatic closing device of claim 1, wherein said connector is selected from the group consisting of a wire, rope, string, chain, webbing, line, and cable.

6. The automatic closing device of claim 1, further comprising an extender pulley having a block and tackle arrangement that is attached to said top end of said controlled return mechanism to double potential door travel distance accommodated by said automatic closing device.

7. The automatic closing device of claim 1, further comprising a bumper positioned under said adjustable mass assembly.

8. The automatic closing device of claim 7, wherein said bumper is selected from the group consisting of a spring, foam, pad, rubber pad, bubble wrap, cushion, and inflated cushion.

9. The automatic closing device of claim 1, wherein said pulley assembly comprises a first pulley disposed in a horizontal plane and a second pulley disposed in a vertical plane.

10. The automatic closing device of claim 9, wherein said connector loops around each of said first pulley and said second pulley.

11. The automatic closing device of claim 1, wherein said pulley assembly comprises a first pulley disposed in a horizontal plane, a second pulley disposed in a vertical plane, and a third pulley disposed in a vertical plane.

12. The automatic closing device of claim 11, wherein said connector loops around each of said first pulley, said second pulley and said third pulley.

13. The automatic closing device of claim 1, wherein said pulley assembly comprises a first pulley disposed in a horizontal plane, a second pulley disposed in a vertical plane, a third spring-loaded pulley disposed in a vertical plane and a fourth pulley disposed in a vertical plane.

14. The automatic closing device of claim 13, wherein said connector loops around each of said first pulley, said second pulley, said third spring-loaded pulley and said fourth pulley.

15. The automatic closing device of claim 1, further comprising a single-motion door latching mechanism configured to hold open or release to close said sliding section of said sliding door assembly at any position along its travel.

16. The automatic closing device of claim 1, wherein said door latching mechanism comprises at least one pulley having a plurality of ramps and a plurality of notches disposed around a circumference of said pulley.

17. The automatic closing device of claim 16, further comprising a finger-like lever having a hinged claw that fits within said plurality of notches to hold said sliding section of said sliding door assembly open at any position along its travel.

18. A sliding door assembly which comprises:
a sliding section that is slidably engaged with a lower horizontal track and an upper horizontal track, wherein said sliding section is laterally movable between a closed position and an open position;
a fixed vertical frame extending from said lower horizontal track to said upper horizontal track; and
an automatic closing device having a controlled return mechanism that generates a force that returns said sliding section to its closed position after said sliding section is opened,
wherein said controlled return mechanism comprises an adjustable mass assembly, a spring, and a connector,
wherein a first end of said connector is attached to a fixed position on said sliding section and a second end of said connector is attached to a top end of said controlled return mechanism, and
wherein a pulley assembly guides said connector from said top end of said controlled return mechanism to said fixed position on said sliding section.

19. The sliding door assembly of claim 18, further comprising single-motion door latching mechanism configured to hold or release said sliding section of said sliding door assembly open at any position along its travel.

20. A method for automatically closing a sliding door assembly comprising the steps of:
sliding a door to its open position, wherein said sliding provides a force to raise an adjustable mass assembly and stretch a spring disposed within said adjustable mass assembly, wherein a tension accumulates in said spring as the spring is stretched; and
releasing said door to its closed position, wherein said releasing allows said spring and said adjustable mass assembly to return said door to its closed position and said tension accumulated in said spring decays as said door approaches said closed position.
